(19) United States
(12) Patent Application Publication
(10) Pub. No.: US 2003/0029795 A1
(43) Pub. Date: Feb. 13, 2003

(54) Apparatus and methods for dispersing one fluid in another fluid using a permeable body

(76) Inventor: George M. Galik, Diamond Bar, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/923,822

(22) Filed: Aug. 7, 2001

(51) Int. Cl. B01D 11/04

(52) U.S. Cl. 210/634; 210/787; 422/256

(57) ABSTRACT

Apparatus for dispersing a first fluid in a second fluid includes a permeable body with a recess for receiving the first fluid. The second fluid can flow from the recess through the permeable body to the exterior of the body. A housing surrounding and spaced from the permeable body has an inlet for a second fluid and an outlet for a mixture of the first and second fluids. A baffle in the space between the permeable body and the housing defines a winding mixing channel through the space between the body and the housing.

In terms of method, a first liquid is disposed in a second liquid by forcing the first liquid through a permeable body and into the second liquid. In a preferred method, material in the first liquid is transferred to the second liquid, which is thereafter passed through a permeable body into a third liquid which has an affinity for the material. Preferably, the liquid on the low pressure side of the permeable body flows under turbulent conditions.

### FIELD OF THE INVENTION

This invention relates to apparatus and methods for dispersing a first fluid of one type in a second fluid of a different type.

### BACKGROUND OF THE INVENTION

In many industries it is often useful to disperse a first fluid of one type in a second fluid of a different type. For example, carbon dioxide gas is dispersed (dissolved) in water to form carbonated water. In another example, liquid-liquid extraction (where two mutually insoluble liquids contact each other) is used to produce pharmaceuticals and other chemicals, treat water, process food, and recover metals from ore. For example, the mining industry has used liquid-liquid ion exchange for many years to recover metal from aqueous leaching solutions, as described in U.S. Pat. No. 5,196,095 issued to Sudderth et al. in 1993, and U.S. Pat. No. 4,683,310 issued to Dalton et al. in 1987. Liquid-liquid ion exchange has also been used for years to recover dissolved copper from etching solutions, such as those described in U.S. Pat. No. 3,705,061 issued to King in 1972, in accordance with a recovery process such as that disclosed in U.S. Pat. No. 5,466,375 issued to Galik in 1995. Each of the four patents mentioned above are incorporated herein by reference.

In a typical liquid-liquid extraction process, one of two liquids, which are of different densities and substantially mutually insoluble, is dispersed in the other to transfer a desired material (such as dissolved metal) in one of the liquids to the other, which has an affinity for the material. For example, in the mining industry, a desired material, say copper, is dissolved from ore in an aqueous leaching solution. Thereafter, the aqueous liquid is contacted with an organic liquid, such as kerosene containing an ion exchange compound which has an affinity for the dissolved metal in the aqueous liquid. Thereafter, the two liquids are separated by settling or centrifuging. The transfer of the metal from the aqueous liquid to the organic liquid is called extraction. Equipment used for extraction requires a mixer and a settler, or a separator.

The rate of transfer of a desired material from one liquid to the other depends on many variables, including the area of contact between the two liquids. Ideally, for maximum transfer rate of material from one liquid the other, one of the liquids should be dispersed as small droplets (the discontinuous phase) in the other liquid (the continuous phase). This produces a high rate of transfer of material from one liquid to the other, but if the droplets of the dispersed liquid are too small, the liquids are difficult to separate, and therefore require long retention time to avoid unacceptable cross-contamination, i.e., prolonged entrainment of one liquid in the other. Consequently, the two liquids are normally agitated together with relatively gentle action to avoid over-dispersion or emulsification of one liquid into the other so that separation can be obtained by gravity or centrifugal action within a reasonable amount of time and space. This compromise slows the rate of transfer of the desired material from one liquid to the other.

U.S. Pat. No. 4,657,401 issued to Galik in 1987 discloses a mixer which uses a rotating impeller to disperse a first liquid in a second liquid for liquid-liquid ion exchange. The disadvantage of a rotating impeller is that the tip speed of the impeller is greater than the inner part of the impeller. Thus, the two liquids are subjected to different stirring action, which forms droplets of both liquids of non-uniform size. The smaller droplets causes the cross-contamination and separation problems mentioned above, and the larger droplets are less efficient in transferring the desired material. Cross-contamination of the organic phase in the aqueous phase results in loss of an expensive reagent, namely, the ion-exchange compound. Cross-contamination of the aqueous phase in the organic phase interferes with subsequent recovery of the desired material. The present invention provides apparatus and methods for obtaining more uniform (and optimized) drop size for the dispersed liquid. This provides a good transfer rate, facilitates separation of the two liquids, and decreases cross-contamination. I achieve this result by forcing one of the liquids through a permeable body to form droplets which mix with the other liquid.

This invention also solves another problem with prior art liquid-liquid ion exchange. Previously, there has been no way to control which liquid is dispensed in the other. For example, in recovering metal from an aqueous solution, the metal is first transferred to an organic solution (the extraction step). Thereafter, the metal must be transferred from the organic liquid to a second aqueous liquid in a “stripping” step so the metal can be recovered by crystallization or electrowinning. In recovering copper from etching solutions, the volume of organic liquid is usually about ten times that of the aqueous liquid in the extraction step, and about two to about three times the volume of the aqueous liquid in the stripping step. Thus, in a dispersion of the two liquids, the organic liquid is usually the continuous phase because of its larger volume. I have found that transfer of the desired material is more efficient if the liquid initially containing the material to be transferred is the discontinuous phase. Thus, in the extraction step, the aqueous liquid is normally the dispersed phase because the volume of organic liquid present is about ten times greater. This is the preferred condition because the aqueous liquid starts with the material to be transferred. However, in the stripping step, which transfers the material from the organic liquid to a second aqueous, the organic liquid, which carries the material to be stripped, is between about 2 and about 3 times greater than the aqueous liquid, and thus is normally the continuous phase. I increase the efficiency of the stripping step by forcing the material-loaded organic liquid to be the discontinuous phase, even though the volume of the organic liquid is twice or more than that of the aqueous liquid. I achieve this result by forcing the organic liquid with the dissolved material through the permeable body and into the second (stripping) aqueous liquid. The organic liquid leaves the permeable body in the form of droplets which, in the preferred method, are swept away by turbulent flow of the second aqueous liquid past the low pressure side of the permeable body. This causes the organic liquid to be dispersed as individual droplets in the aqueous liquid, resulting in more efficient stripping (transfer) of the material from the organic liquid into the second aqueous liquid where the material can be crystalized, or recovered by electrowinning if the material is dissolved metal.

Even in applications where the organic and aqueous liquids are present in about equal volumes, as in some mining operations, this invention provides for the dispersal of either liquid as the discontinuous phase for maximum efficiency.

Moreover, by using a permeable body with pores of a size to provide droplets of optimum size, subsequent coalescing of the dispersed phase is facilitated, thereby minimizing the cross-over problem described above. In general, good results are obtained by using a permeable body which has pores, most of which have an equivalent diameter between about 0.2 microns and about 200 microns.

Another disadvantage of prior art liquid-liquid ion exchange systems for dispersing one liquid in another is that air bubbles are entrained during the dispersing step. The entrained air interferes with material transfer and with coalescence of the dispersed liquid, and delays separation of the two liquids. This invention avoids the formation of air bubbles as one liquid is dispersed in the other, thus providing a more efficient recovery of the desired material.

### SUMMARY OF THE INVENTION

This invention provides improved methods and apparatus for dispersing droplets or bubbles of a first fluid in a second fluid. In one embodiment, the dispersed fluid is a gas, such as carbon dioxide, and the other fluid is a liquid, such as water. In another embodiment, the dispersed fluid is a liquid, say a salt solution, and the second fluid is a stream of hot gas, to evaporate the dispersed liquid and produce a dried salt. In a third embodiment, the dispersed fluid is a liquid dispersed in a second liquid, which is substantially insoluble in the first liquid, and of a different density.

In terms of apparatus for dispersing a first fluid in a second fluid, the invention includes a permeable body having a recess in it for receiving the first fluid, which can flow from the recess through the permeable body to the exterior of the body. A housing surrounding and spaced from the permeable body has an inlet for the second fluid to enter the space between the permeable body and the housing, and an outlet for a mixture of the first and second fluids. A baffle in the space between the permeable body and the housing has an outer portion adjacent the housing interior and an inner portion adjacent to body exterior, and the baffle is shaped to define a winding mixing channel through the space between the body and the housing so the second fluid can enter the housing inlet and flow through the winding channel to the housing outlet and mix with the first fluid which can flow from the recess through the permeable body and into the winding channel. Preferably, the baffle defines a winding mixing channel in the shape of a helix, and the permeable body has pores, the majority of which have an equivalent diameter between about 0.2 microns and about 200 microns. Preferably, the permeable body is made up of sintered metal particles which have the consistency of powder prior to sintering. The permeable body can also be made of permeable ceramic material.

In a preferred embodiment, the baffle is made from a series of segments. Initially, each segment is in the form of an elongated, flat strip disposed along a generally elliptical path having a major axis and a minor axis. The strip is wider where it crosses the major axis than where it crosses the minor axis. Preferably, the ends of the strip terminate adjacent each other in the vicinity of the minor axis on one side of the ellipse. The adjacent ends of the strip are closer to the major axis than the part of the strip at the minor axis and on the other side of the major axis from the ends of the strip. Each strip has an inner edge and an outer edge disposed so the inner and outer edges are substantially parallel, and so the inner edge forms a ceratoid cusp at the ends of the strip. Preferably, the strip is made of stainless steel inert to the liquids, and shaped so that when the ends of the strip are in the vicinity of the minor axis and are moved relative to each other in a direction substantially parallel to a third axis which is perpendicular to the major and minor axes, the strip is deformed from a flat plane to an orientation where the outer and inner edges of the strip each respectively make a snug fit against the inner surface of a first pipe and the outer surface of a second pipe co-axially disposed within the first pipe.

Another embodiment of the invention provides apparatus for transferring material in a first liquid to a second liquid which has an affinity for the material, and which is substantially insoluble in the first liquid; and for transferring material in the second liquid to a third liquid which has an affinity for the material, and which is substantially insoluble in the second liquid. The apparatus includes a first mixer which has a first permeable body with a first and second side. A first flow channel in the mixer directs the first liquid against the first side of the body to cause the first liquid to flow through the body and emerge from the second side of the body. The first mixer also includes a second flow channel for directing the second liquid to flow in contact with the second side of the first body to form a first dispersion of droplets of the first liquid in the second liquid so material transfers from the first to the second liquid. The apparatus also includes a first separator having an inlet connected to the first mixer to receive the first dispersion from the first mixer. The first separator has a first outlet for the first liquid from which material has been removed, and a second outlet for the second liquid with the transferred material in it. A second mixer, which includes a second permeable body having a first side and a second side, has a first flow channel connecting the second outlet of the separator to direct the second liquid with the material in it against the first side of the second body to cause the second liquid and material in it to flow through the second body and emerge from the second side of the body. A second flow channel in the second mixer directs the third fluid in contact with the second side of the second body to form a second dispersion in which droplets of the second liquid with material are dispersed in the third liquid so material transfers from the second to the third liquid.

In terms of method for forming a dispersion of a first liquid in a second liquid which is substantially insoluble in the first, invention includes the steps of forcing the first liquid through a permeable body so the first liquid emerges from the body in the form of droplets, and flowing the second liquid past the body where the droplets emerge to form a dispersion of droplets in the second liquid. Preferably, the second liquid flows past the body under turbulent conditions so that droplets of the first liquid are quickly dispersed before having an opportunity to coalesce. The permeable body preferably has pores with equivalent diameters between about 0.2 microns and about 200 microns. Preferably, most of the pores are between about 20 and about 100 microns. In a preferred method, the dispersion of the two liquids is separated by centrifugal action so the second liquid can be further processed for recovery of material in it.

In a method for transferring material in a first liquid to a second liquid which is of a different density and substantially insoluble in the first liquid, and which has an affinity for the material, the invention includes passing the first liquid and material through a permeable body, and contacting the first liquid and material which pass through the body with the second liquid. In a preferred method, the first liquid is dispersed as droplets in a continuous phase of the second liquid.

In another method of this invention, material dissolved in an aqueous solution is recovered by passing the aqueous solution of dissolved material through a permeable body, and contacting the aqueous solution and dissolved material which passes through the body with a continuous phase of an organic liquid which has an affinity for the material, and which is substantially insoluble in water. In another method of this invention, material in an organic liquid which is substantially insoluble in water is recovered by passing the organic liquid and material through a permeable body and contacting the organic liquid and material which pass through the body with a continuous phase of an aqueous solution which has an affinity for the material. In each of the three methods just discussed, the permeable body has pores, the majority of which have equivalent diameter between about 0.2 and about 200 microns, and preferably the continuous phase is moved past the body at a rate to generate turbulent flow.

### BRIEF DESCRIPTION OF THE DRAWINGS

The invention will be more fully understood from the following detailed description and the accompanying drawings in which:

FIG. 1, taken on line 1-1 of FIG. 2, is a longitudinal sectional elevation, partly broken away, of a mixer made in accordance with this invention;

FIG. 2 is a view taken on line 2-2 of FIG. 1;

FIG. 3 is a plan view of a segment of a baffle used in the mixer of this invention;

FIG. 4 is a diagram of apparatus showing mixers and separators used in accordance with this invention;

FIG. 5 is a vertical sectional view, partly broken away, of one of the separators of FIG. 4 with an inlet connected to the outlet of one of the mixers;

FIG. 6 is a view taken on line 6-6 of FIG. 5 showing the top of a rotatable tank in the separator;

FIG. 7 is a view taken on line 7-7 of FIG. 6; and

FIGS. 8-12 are plots of data obtained with the apparatus and methods of this invention showing the recovery of dissolved copper from spent etching solution.

### DETAILED DESCRIPTION OF THE INVENTION

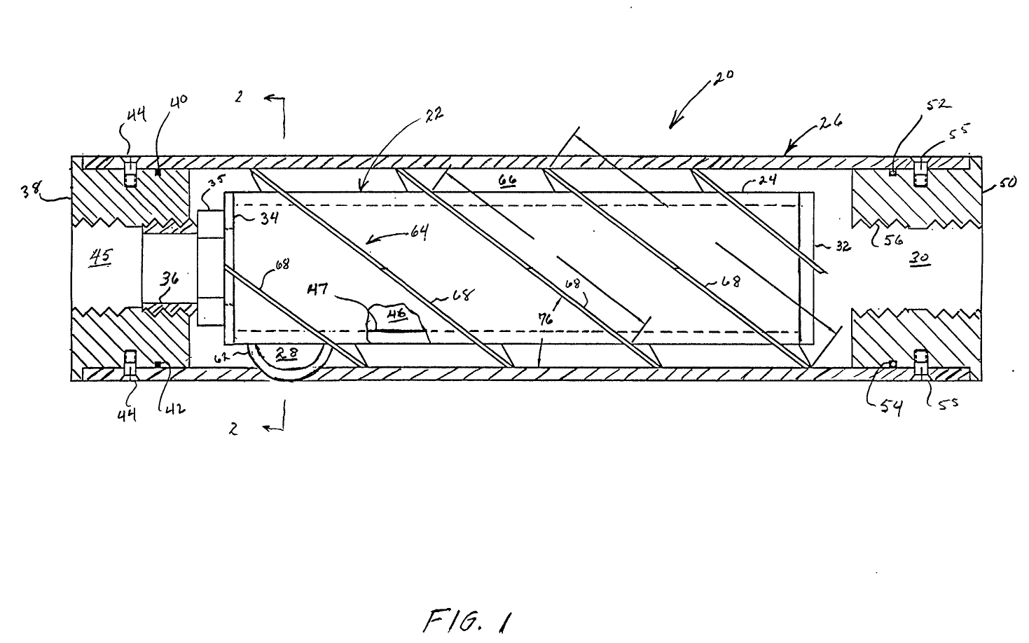

Referring to FIG. 1, a mixer 20 includes a permeable body 22 in the shape of a cylindrical tube 24 coaxially disposed within an elongated cylindrical housing 26 having a lateral inlet 28 at one end and a longitudinal outlet 30 at the other end of the housing. A disk 32 closes the end of the permeable body adjacent the housing outlet. An annular plate 34 secured to the end of the permeable body adjacent the housing inlet carries a hex nut 35 to which is secured a longitudinally extending externally threaded nipple 36 threaded into the inner end of an annular inlet end collar 38, which makes a snug fit inside the inlet end of the housing. An O-ring 40 in an outwardly opening annular groove 42 seals the collar against the housing interior. A pair of set screws 44 located between the O-ring 40 and the inlet end of the housing extend through the housing wall and are threaded into the outer surface of the collar 38 to anchor the collar in place. An internally threaded bore 45 in inlet end collar 38 receives an externally threaded conduit (not shown) for delivering a first fluid to a recess 46 within the permeable body, which has a relatively thin cylindrical wall 47.

An outlet end annular collar 50 makes a snug fit in the outlet end of the housing, and is sealed to the housing by an annular O-ring 52 in an outwardly opening annular groove 54 around the outlet end collar. A pair of set screws 55 between O-ring 52 and the outlet end of the housing extend through the housing wall and are threaded into the outer surface of the collar 50 to anchor the collar in place. Internal threads 56 in the outlet end collar receive a conduit (not shown) for delivering fluid from the outlet end of the housing.

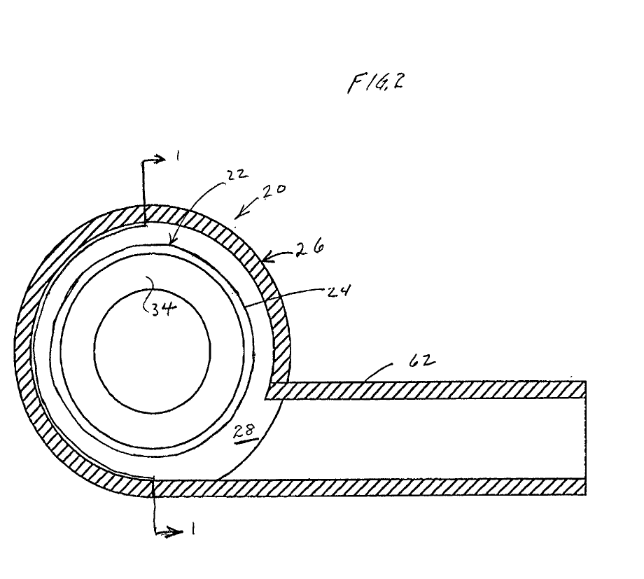

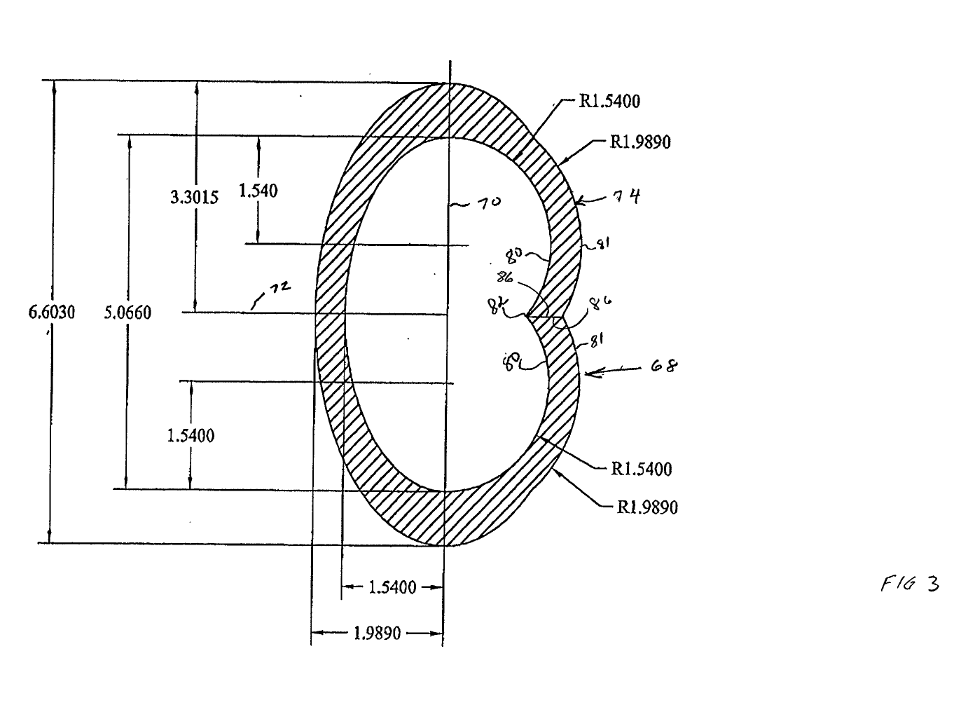

As shown best in FIGS. 1 and 2, the housing inlet 28 extends through the housing wall adjacent the inlet end of the housing, and is connected to an inlet conduit 62 for admitting a second fluid to the housing inlet end. A helical baffle 64 in the annular space 66 between the exterior of the permeable body 22 and the inner surface of the cylindrical housing defines a winding mixing channel between the inlet and outlet of the housing. Preferably, the baffle is made of segments 68 (one of which is shown in FIG. 3) connected in series as described below. Each baffle segment 68 is made of an elongated strip 74 initially laid out in a flat plane along a path in the general shape of an ellipse having a major axis 70 and a minor axis 72.

As shown in FIG. 1, the helical baffle 64 extends around the permeable body 22 so the helix has a “lead” or “pitch” equal to about one-fourth the length of the permeable body. Therefore, four baffle segments 68 connected end-to-end are required to provide the helical baffle 64 because each segment extends about 360° around the permeable body. Each baffle segment is made of stainless steel, and is about 1/16th inch thick.

In one embodiment of the mixer, the exterior diameter of the permeable body 22 is about 3 inches and the interior diameter of the cylindrical housing is about 4 inches, and the dimensions in inches of each baffle segment are as indicated on FIG. 3. The overall length of each baffle segment along its respective major axis 70 is about 6.6 inches, and the width of each baffle segment where the baffle segment crosses the major axis is about 0.8 inches. The width of each baffle segment in the vicinity of the minor axis is about 0.45 inches. Some radii of curvature of the inner edge 80 and the outer edge 81 of each baffle segment are shown in FIG. 3. The right (as viewed in FIG. 3) side of each baffle segment where it crosses the minor axis curves inwardly to be closer to the major axis than is the opposite side of the baffle segment. Moreover, the right (as viewed in FIG. 3) inner edge 80 of the baffle segment forms an inwardly extending ceratoid cusp 82 on the minor axis of the segment. The outer and inner edges of the baffle are substantially parallel throughout the length of the baffle segment. Each baffle segment is separated along the minor axis at the ceratoid cusp so that each baffle segment has free ends 86 terminating at the minor axis on the right side of the segment. This permits each baffle segment to be deformed into one-fourth of the helix shown in FIG. 1. For example, referring to FIG. 3, if the free ends of the strip forming the baffle segment 68 are displaced from each other in a direction substantially parallel to an axis perpendicular to the major and minor axes of the ellipse, the baffle segment deforms so the outer edge 81 of the segment makes a close fit around the interior of the cylindrical housing 26, and the interior edge 80 of the baffle makes a snug fit around the cylindrical exterior of the permeable body 22. Four baffle segments 68 identical to that shown in FIG. 3 disposed end to end in the annular space 66 between the permeable body and the housing make the complete helical baffle shown in FIG. 1 so that fluid entering housing inlet 28 follows a helical mixing channel through the annular space 66 to reach housing outlet 30.

The permeable body 22 in the mixer can be made of any suitable material, such as powdered metal particles or ceramic. A satisfactory permeable and porous body for the purpose of this invention is sold by Mott Metallurgical Corporation of Farmington, Conn. Literature published by Mott describing permeable porous metal products and entitled “Engineering with Precision Porous Metals” is attached hereto as Appendix A and incorporated herein by reference. The permeable and porous body used in this invention preferably has substantially uniform pore sizes, or at least most of the pores are within an acceptable range for the intended purpose. As explained in the attached Appendix A, “in general, porous structures fabricated from metallic powder always exhibit a distribution of pore sizes”. This distribution is determined by the statistical packing of metal particles as they are packed into a porous matrix. During packing, particles tend to “bridge” and form pores within the structure larger than those formed when particles are perfectly packed for maximum density. Various manufacturing techniques are used to minimize the bridging effect, but it is not practical to eliminate it entirely, even when completely spherical metallic particles of identical size comprise the matrix. In any event, this invention works well with permeable and porous media sold by Mott, and with pore sizes stated by the manufacturer to be in the range of 0.2 to 100 microns. The porous and permeable body can be made of any suitable material which is inert to the liquids handled by the mixer. For example, the body can be made of particles of many differential materials, such as stainless steel, Nickel 200, Monel® 400, Inconel® 600, Hastelloy® C276, Alloy 20, gold, platinum, silver, and titanium.

In one embodiment of the invention, the length of the permeable porous body is about 12 inches, and the wall thickness is about 0.07 inches. The outside diameter of the permeable body is about 3 inches. The interior diameter of the cylindrical housing is about 4 inches. The opening of the housing inlet to the annular space is about 1.5 inches in diameter. The inlet to the recess in the permeable and porous body and the outlet at the discharge end of the mixer each have an inside diameter of 1.5 inches. The cross-sectional area of the helical channel defined by the baffle between the porous body and the housing interior is the equivalent of a circular pipe having an interior diameter of about 1.4 inches. Without the baffle, the annular space between the permeable body and the housing is about 2.6 inches. Using spent aqueous etching solution and conventional organic liquid, such as kerosene with an ion exchange reagent (say, a hydroxy oxime sold under the trademark LIX84N by Henkel Corporation of Tucson, Ariz.), a flow of 26 gallons per minute (3 gallons per minute of aqueous solution through the permeable body, plus 23 gallons per minute of organic liquid into housing inlet 28) through the helical mixing channel around the permeable body in the mixer shown in FIG. 1 gives a Reynolds number between about 23,000 and about 25,000. Turbulent flow occurs in the mixture at a Reynolds number between about 2,000 and about 4,000. Without the baffle, at a flow rate of 26 gallons per minute, the Reynolds number is about 13,000.

An important advantage of the helical baffle used in the mixer disclosed above is that the baffle can divide the annular space between the exterior of the permeable body and the interior of the surrounding housing into a mixing channel which provides turbulent flow for any standard size permeable body and surrounding housing. For example, the permeable body of porous metal is available commercially from Mott Metallurgical Corporation in different sizes. Thus, any convenient size can be selected “off the shelf” and fitted into any convenient size commercial pipe, say polyvinylchloride tubing. With the example given above, the permeable body having an outside diameter of about three inches is easily mounted within commercially available polyvinylchloride tubing having an inside diameter of about four inches. Without the baffle, the annular space between the permeable body and the housing interior would have an equivalent pipe internal diameter of 2.6 inches. With the baffle in place as shown in FIG. 1, the equivalent pipe diameter is 1.38 inches. Thus, the Reynolds number with the baffle in place is about twice that compared to flow through the annual space without the baffle. This improves dispersion of the noncontinuous liquid over a wide flow range. Moreover, with the baffle in place, the equivalent pipe diameter of the helical channel is substantially the same as that of the mixer inlets. Thus, the Reynolds number is well above the critical velocity required for turbulent flow over a wide range of flow rates, say from about 10 gallons per minutes to 35 gallons per minute.

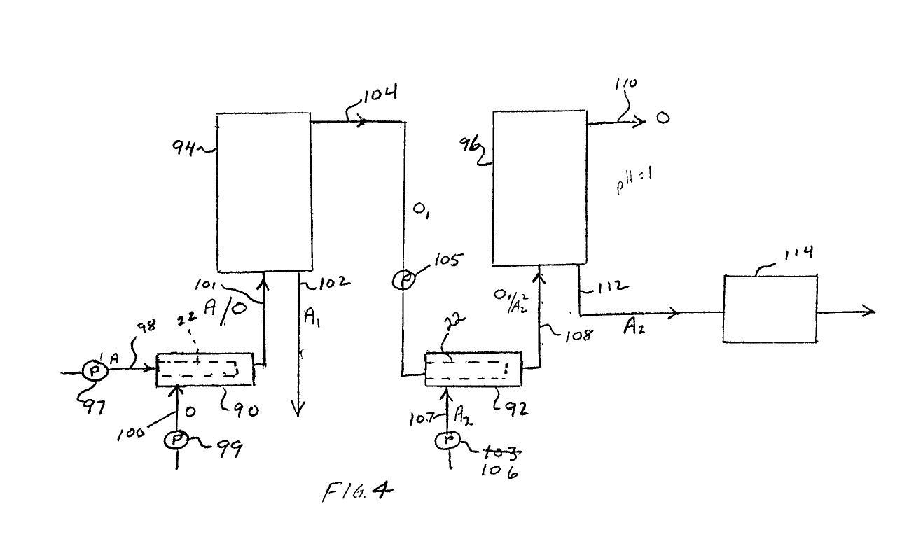

FIG. 4 shows first and second mixers 90 and 92 of the type disclosed above connected to first and second separators 94 and 96, respectively. The separators are of the centrifugal type shown in U.S. patent application Ser. No. 09/664,277 filed Sep. 18, 2000 by George M. Galik. The disclosure of that application is incorporated herein by reference. The separators shown in FIG. 4 differ from that disclosed in the Galik application in that the mechanical impeller at the bottom of the separator disclosed in the application is omitted. Instead of an impeller, a mixer of this invention is used to supply a dispersion of one liquid in another to the inlet at the bottom of the separators.

Referring to FIG. 4, an aqueous solution of spent etchant, such as that produced in accordance with the method disclosed in the King patent referred to above, is introduced by a first pump 97 through a spent etchant supply line 98 to the first mixer 90 so that the spent etchant enters the recess 46 (shown in FIG. 1) within the permeable body 22 in the first mixer. An organic liquid extractant containing a hydroxy oxime ion exchanger, such as that sold under the trademark LIX84N by Henkel, is introduced by a second pump 99 through an organic inlet line 100 to the inlet of the mixer to enter the helical mixing channel between the mixer housing and the permeable body. The aqueous liquid is forced through the permeable body to form droplets (not shown) on the exterior surface of the permeable body where the droplets are swept away by turbulent flow of organic liquid through the helical mixing channel defined by the mixer baffle. The dispersion leaves the mixer through the outlet and is carried by supply line 101 to the inlet of the first separator 94.

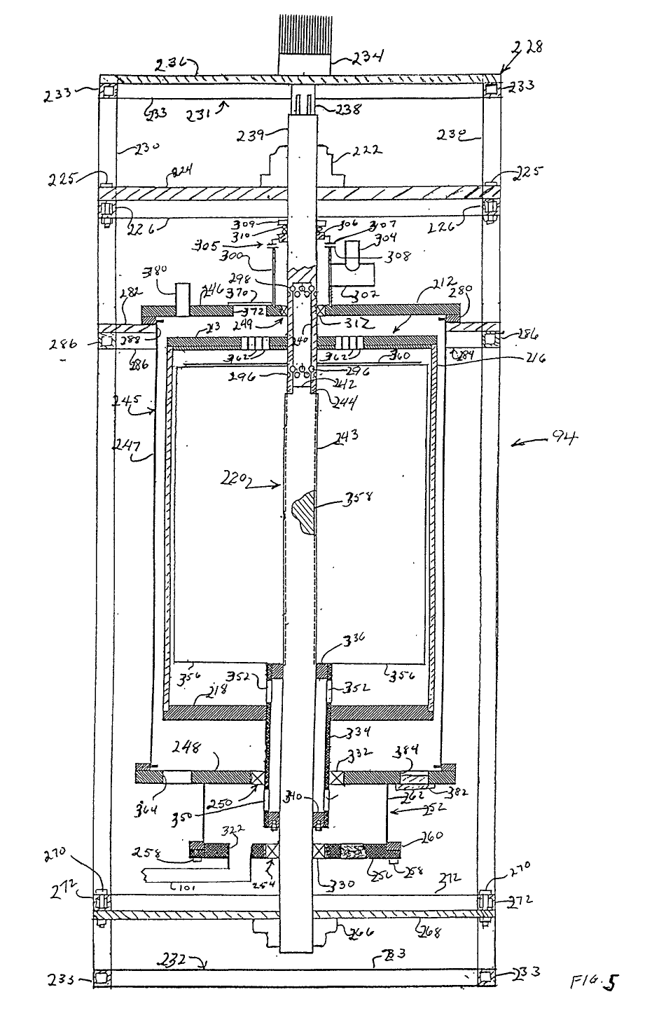

FIGS. 5-7 show how supply line 101 is connected to an inlet 322 in the bottom of the first separator 94.

Referring to FIG. 5, the separator 94 includes a rotatable tank 212 in the shape of a vertical right cylinder having a horizontal annular upper or outlet wall 213, a vertical cylindrical side wall 216, and a horizontal annular lower or outlet end wall 218. A vertical drive shaft 220 is suspended at its upper end by an upper thrust bearing 222 mounted on a horizontal upper support plate 224 secured by bolts 225 to the upper surfaces of four horizontal cross-members 226 in the upper part of an upright frame 228, which in plan view (not shown) is in the shape of a square. Only three of the four cross-members 226 are shown. A separate elongated vertical column 230 forms each corner of the frame. Only two of the four columns 230 are shown. An upper end set 231 and a lower end set 232 of four horizontal cross-bars 233 are welded at their respective ends to the respective upper and lower ends of columns in the frame. Only three of the four cross-bars in each set are shown. The columns 230, cross-members 226, and cross-bars 232 can be of any suitable material. I have found that 2″×2″×0.250″ steel square tubing to be satisfactory.

A motor 234, which may be electric or hydraulic, is mounted on a horizontal top plate 236 secured across the upper end of the frame, and has a vertical motor shaft 238 with external splines which fit down into the upper end of an upper section 239 of the drive shaft 220. The upper end of the upper section 239 has internal splines (not shown) to mate with the external splines on the motor shaft 238.

The upper section 239 of the drive shaft extends down through and is welded to the inner periphery of the annular outlet end wall 213 of the tank. The lower end of the upper section 239 of the drive shaft includes an elongated vertical bore 240, which opens out of the lower end of section 239. An upwardly extending circular boss 242 on the upper end of a lower section 243 of the drive shaft makes a snug fit into the lower end of the bore 240. The lower end of the upper section 239 rests on an annular shoulder 244 surrounding the boss 242.

A stationary cylindrical tank housing 245 coaxially disposed around the rotatable tank includes an annular horizontal upper end wall 246 spaced slightly above the upper end wall 213 of the tank, a vertical cylindrical side wall 247, and an annular horizontal lower end wall 248 spaced below the lower wall of the tank. The outlet and inlet end walls of the stationary housing each include a separate central bore 249 and 250, respectively, down through which the drive shaft extends. The lower section 243 of the drive shaft extends down through the center of a cylindrical casing 252 secured to the underside of the lower end wall of the housing, and down through a vertical bore 254 in the center of a horizontal annular bottom 256 secured by bolts 258 to an outwardly extending angular flange 260 on the lower end of the cylindrical casing 252, and down through a steady-rest bearing 266 secured to the underside of a generally rectangular bottom support plate 268 fastened by bolts 270 between adjacent columns 230 to the underside of four horizontal cross-members 272 welded at their respective ends to vertical columns 230 of the frame. Only three of the four cross-members 272 are shown. The upper end of the cylindrical casing 252 of the mixing unit is welded to the underside of the lower end wall 248 of the housing. The lower section of the drive shaft is free to move longitudinally with respect to the steady-rest bearing to accommodate expansion and contraction of the apparatus in response to any changes in temperature which may occur during operation.

The housing upper end wall 248 includes an outwardly extending annular flange 280 secured by bolts (not shown) to the top of a housing support plate 282 anchored by bolts (not shown) on top of a set 284 of four horizontal cross-members 286 welded at their ends to respective column 230 of the frame 228. Only three of the four cross-members 286 are shown. The housing cylindrical side wall makes a close fit down through a circular opening 288 in the housing support plate 282.

The lower end of the upper section 239 of the drive shaft terminates in the upper part of the rotatable tank, and includes a plurality of radially extending inlet ports 296 adjacent the lower end of bore 240 so a light liquid (not shown) can flow from the tank into the bore 240 as described below. A group of radially extending outlet ports 298 through the side wall of the upper section 239 of the drive shaft at the upper end of bore 240 above the housing upper end wall 246 permit light liquid to flow outwardly from the bore 240 and into a collector sleeve 300 mounted on top of the outlet end of the tank housing coaxially around the drive shaft. The collector sleeve includes a laterally extending discharge tube 302 for light liquid to flow to storage or further processing. The lower end of a vertical vent tube 304 is connected to the lateral tube 302 to prevent pressure build up within the light liquid discharge tube 302. A first rotating seal 305 makes a static seal 306 against the drive shaft, and makes a sliding seal 307 against an annular seat 308 on the upper end of the collector sleeve. An adjustable clamp 309 secured around the shaft urges a compression spring 310 against the static seal 306 and toward the annular seal 308 to maintain liquid tight contact at sliding seal 307. The rotating seal 305 may be of any suitable commercially available type, such as a standard seal available from Harbor Seal, Incorporated at 909 Myrtle Avenue, Monrovia, Calif. 91016. A second rotating seal 312 (similar to seal 305, and shown only schematically) makes a static seal against the drive shaft and makes a sliding seal against an annular seat (not shown) around central opening 249 of the upper end wall 246 of the housing 245.

A vertical bore 322 through the bottom 256 of the mixer forms an inlet for the dispersion of the aqueous liquid in the organic liquid delivered through supply line 101 from the first mixer 90 (FIG. 4).

A third rotating seal 330 (similar to the first, and shown only schematically), makes a static seal around the lower section of the drive shaft and a sliding seal against an annular seal (not shown) disposed around the central bore 254 in the annular bottom of the mixing unit. A fourth sliding seal 332 makes a static seal around a vertical inlet tube 334 and a sliding seal on an annular seat (not shown) around the central opening 250 in the lower end wall of the housing. The third and fourth rotating seals are similar to the first seal 305, and are shown only schematically. The upper end of the inlet tube extends into a lower portion of the rotatable tank and is welded to the inner periphery of the annular lower wall 218 of the tank. The lower section of the drive shaft is welded to the inner periphery of a first annular ring 336 welded inside the upper end of the inlet tube. A second annular ring 340 is welded inside the lower end of the inlet tube, which terminates in the mixing unit just above annular horizontal bottom 256. The lower section of the drive shaft is welded to the inner periphery of the second annular ring 340. The mixed liquids in supply line 101 inlet openings 350 in the lower end of the inlet tube below lower end wall 248 of the housing 245. The mixed liquids flow out openings 352 in the upper end of the inlet tube above the lower end wall 218 of the rotatable tank.

Four vertical and radially extending separator baffles 356 are mounted at equal intervals around the exterior of the drive shaft. Only two of the four vertical baffles are shown. The inner edge of each vertical baffle is welded in a separate respective vertical groove 358 formed in the exterior of the drive shaft. The inner portion of the lower edge of each vertical baffle rests on the upper end of the inlet tube. The outer edge of each vertical baffle terminates a short distance from the interior surface of the tank wall 216. The upper edge of each vertical baffle terminates in the tank just below an annular horizontal baffle 360. The upper section of the drive shaft just above inlet ports 296 is welded to the inner periphery of the annular horizontal baffle 360.

Thus, mixed liquids entering the lower end of the rotating tank are subjected to centrifugal action by the vertical baffles, causing the heavy (aqueous) liquid to flow outwardly and concentrate the light (organic) liquid around the drive shaft. The light liquid flows into inlet ports 296 of the drive shaft and out outlet ports 298 into the collector 300 from which light liquid is removed by discharge pipe 302 for storage or further treatment.

Heavy liquid flows up through the annular space between the outer periphery of the annular horizontal baffle 360, and inwardly in the space between the horizontal baffle in the upper end wall of the tank. Heavy liquid flows upwardly out of the tank through vertical tank outlet ports 362 in the upper end wall of the tank, and into and down through the annular space between the housing side wall and the tank side wall. Heavy liquid leaves the housing through a vertical exit port 364 through the lower end wall 248 of the housing 245.

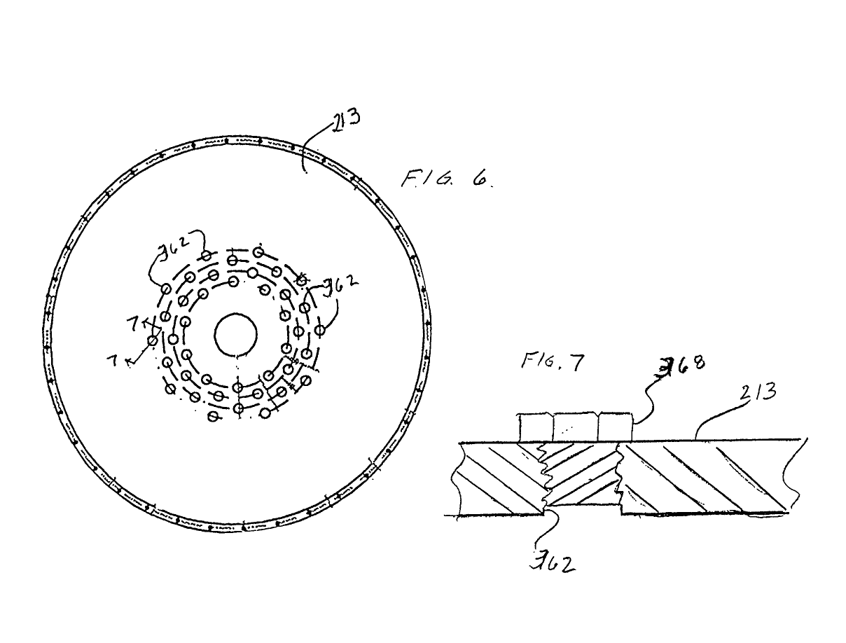

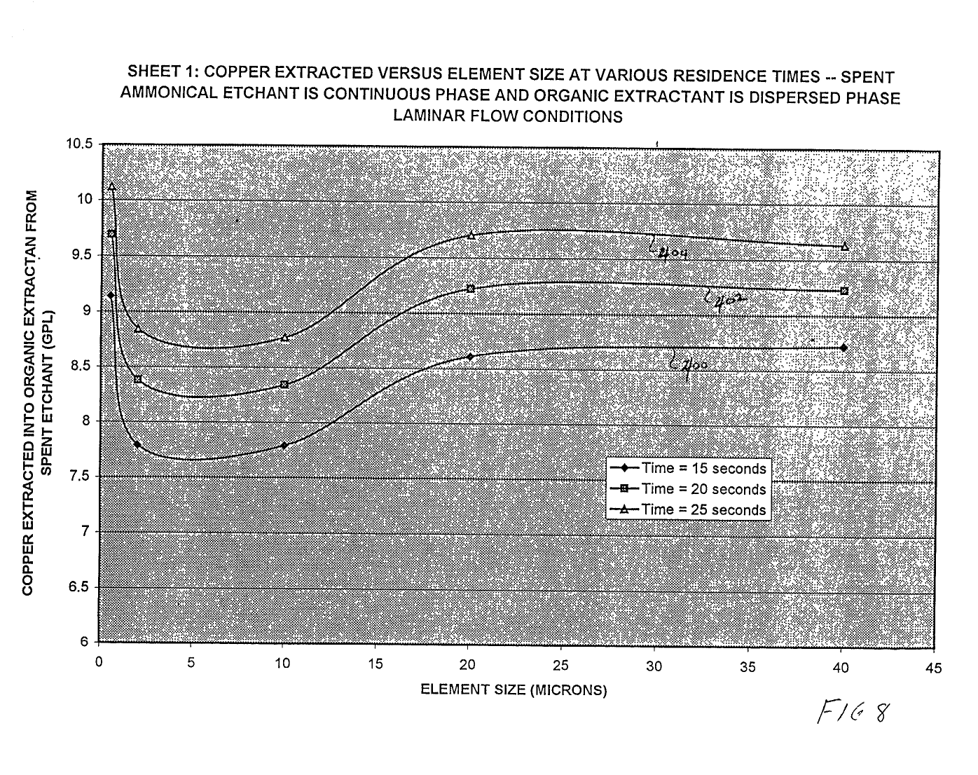

As shown in FIG. 6, the outlet ports 362 in the upper end wall of the tank are located on concentric circles disposed coaxially around the axis of tank rotation. As shown in FIG. 7, each outlet port 362 is internally threaded, and can be opened or closed by an externally threaded plug 368. Thus, depending on operating conditions, the annular zone of separation of the heavy and light liquids in the tank can be adjusted by opening or closing selected outlet ports 362. A removable cover 370 over a vertical opening 372 in the upper end wall 246 of the housing permits access to the upper ends of the outlet ports 362 to facilitate inserting or removing plugs 368 to achieve the desired location of the separation zone of heavy and light liquids in the tank.

A vent tube 380 extending through the upper end wall 246 of the housing vents the interior of the housing to the atmosphere.

A removable plug 382 in a vertical drain port 384 extending through the lower end wall 248 of the housing permits the housing to be drained for periodic cleaning.

The separator apparatus and method described above provides fast, efficient, and low-cost mixing and separation of liquids of different densities and which are substantially mutually insoluble. The mixing unit ensures intimate dispersion of one liquid within the other, and the centrifugal action of the separator rapidly separates the two liquids. Moreover, the use of the sturdy frame to carry the weight of the apparatus and the liquid undergoing treatment permits the rotatable tank to be constructed of rolled sheet metal stock, resulting in low material and manufacturing costs. For example, the cylindrical sidewall 216 of the rotatable tank can be rolled from relatively thin sheet metal, say ⅜″.

Any suitable material can be used to make those parts of the apparatus which contacts the liquids used in the process, but I prefer to use titanium or stainless steel which is not affected by the liquids.

The travel (residence) time for the dispersion in the mixer and supply line 101 is sufficient to permit substantial transfer of copper in the spent etching solution (aqueous liquid) to the organic liquid. Ordinarily, a residence time of between about 5 and about 20 seconds is sufficient.

The aqueous liquid from which copper has been extracted leaves the first separator through an aqueous liquid discharge line 102. Organic liquid to which copper has been transferred leaves the first separator through organic outlet line 104. A third pump 105 forces the organic liquid and extracted copper into the recess 46 of the permeable body in the second mixer 102. A fourth pump 106 supplies an aqueous stripping liquid, such as a solution of sulfuric acid, to the inlet of the second mixer through a supply line 107. The organic liquid flows through the permeable body 22 in the second mixer and emerges on the low pressure side of the permeable body in the form of droplets (not shown), which are swept away by turbulent flow of the stripping liquid through the helical mixing channel formed in the annular space between the permeable body and the interior of the housing of the second mixer. A second dispersion (of organic liquid droplets in a continuous medium of the acidic aqueous stripping liquid) flows from the outlet of the second mixer through a second supply line 108 into the inlet of the second separator, which is identical with that described above with respect to FIGS. 5-7. The travel time of the second dispersion from the second mixer to the second separator is sufficient to allow substantial stripping of the copper from the organic extractant liquid to the acidic aqueous stripper liquid. Ordinarily, a travel time of between about 5 and about 20 seconds is adequate.

Organic liquid from which copper has been stripped leaves the second separator through outlet line 110. Acidic aqueous liquid loaded with copper stripped from the organic liquid leaves the separator through an outlet line 112, and is delivered to a copper recovery unit 114, such as a crystalizer for forming copper sulfate crystals, or an electrowinning unit for recovering elemental copper.

During the extraction phase, the volume of organic liquid is about 10 times that of the aqueous liquid. Since the aqueous liquid flows through the permeable body in the first mixer, the aqueous liquid is dispersed as droplets throughout a continuous phase of organic liquid.

In the stripping step, the volume of the organic liquid is between about 2 and about 3 times that of the aqueous liquid. However, since the organic liquid is forced through the permeable body in the second mixer, the organic liquid forms a dispersion of organic liquid droplets in a continuous phase of aqueous liquid. Thus, at the beginning of the extraction and stripping steps, the dispersed liquid carries the material (copper) to be transferred. This ensures good extraction and stripping efficiency as explained below in connection with the data plotted in FIGS. 8-12.

FIG. 8 presents data showing the amount of copper extracted in accordance with this invention from a spent ammoniacal aqueous etching solution. The concentration of copper in the spent etching solution was 136.1 grams per liter, the pH of the solution was 8.3, chloride concentration was 156 grams per liter, and free ammonia was 4.3 normal. The organic extractant was virgin material, i.e., it contained no dissolved copper, and was composed, by volume, of 25% L1X84 and 75% kerosene. The ammoniacal etchant was the continuous phase, and the organic extractant liquid was the disbursed phase under laminar flow conditions obtained by mounting the permeable body 22 (without the housing) shown in FIG. 1, in a vertical position in a column (not shown) of spent ammoniacal etchant. The virgin organic extractant was introduced through the bore 45 to the recess 46 inside the permeable body so that organic liquid was forced through the permeable body and rose as droplets (dispensed phase) under laminar flow conditions through the spent etchant in the column. The organic etchant floated to the top and was collected and analyzed for copper under three different travel times (15, 20, and 25 seconds) of the dispersed phase from the mixer, and using five different permeable bodies having pore sizes reported by the supplier, Mott Metallurgical Corporation, as 0.5, 2.0, 10, 20, and 40 microns. Curve 400 in FIG. 8 shows copper recovery after a travel time of 15 seconds for each of the five different porous bodies. Curves 402 and 404 show similar data for reaction times of 20 and 25 seconds, respectively.

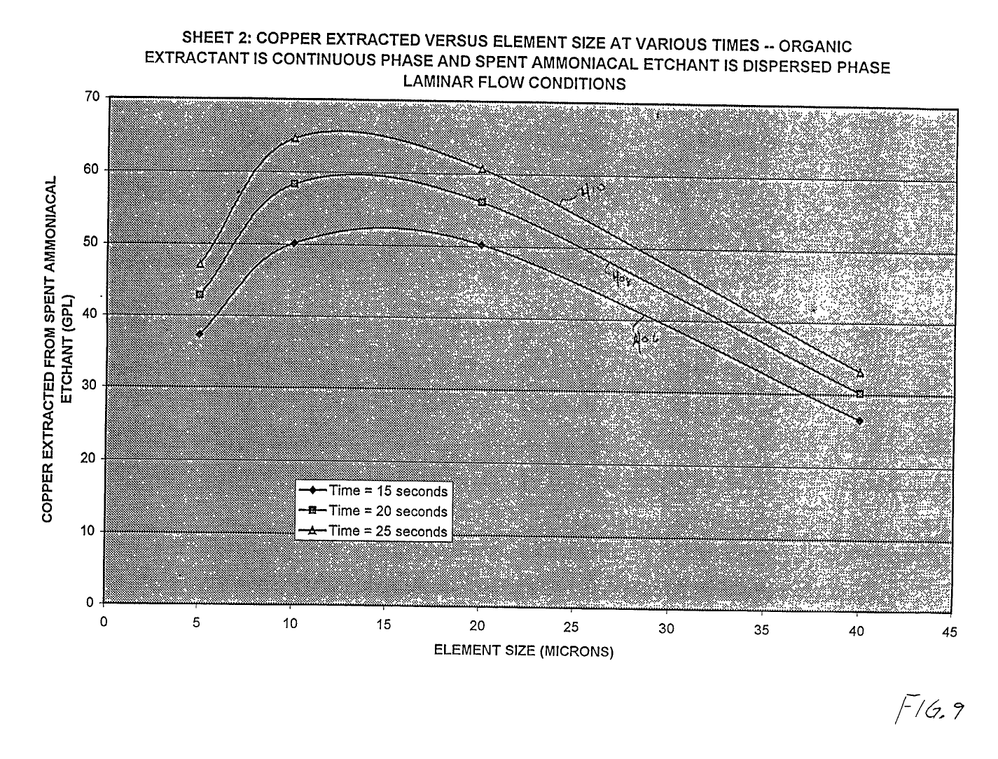

FIG. 9 presents data showing how copper recovery increased when the aqueous ammoniacal etching solution was dispersed as the discontinuous phase in a continuous phase of organic extractive liquid. The test conditions for the data shown in FIG. 9 the same for the data shown in FIG. 8, except the column was filled with organic extractant liquid, and the spent ammoniacal liquid etchant was forced through the permeable body to form a dispersed phase of aqueous liquid droplets in the continuous phase of organic liquid. The spent etchant settled in the column filled with organic liquid extractant, and was collected at the bottom of the column and analyzed for copper. The advantage of dispersing the aqueous ammoniacal etchant solution as the discontinuous phase is apparent from comparing the curves 406, 408, and 410 of FIG. 9 with curves 400, 402, and 404, respectively, in FIG. 8. For example, using a permeable body having a nominal pore size of 10 microns and a reaction time of 15 seconds, the recovery of copper when the ammoniacal etchant was the continuous phase was only about 7.8 grams per liter at a reaction time of 15 seconds (curve of 200 in FIG. 8), compared to recovery of 50 grams of copper per liter when the aqueous ammoniacal etching was the dispersed phase.

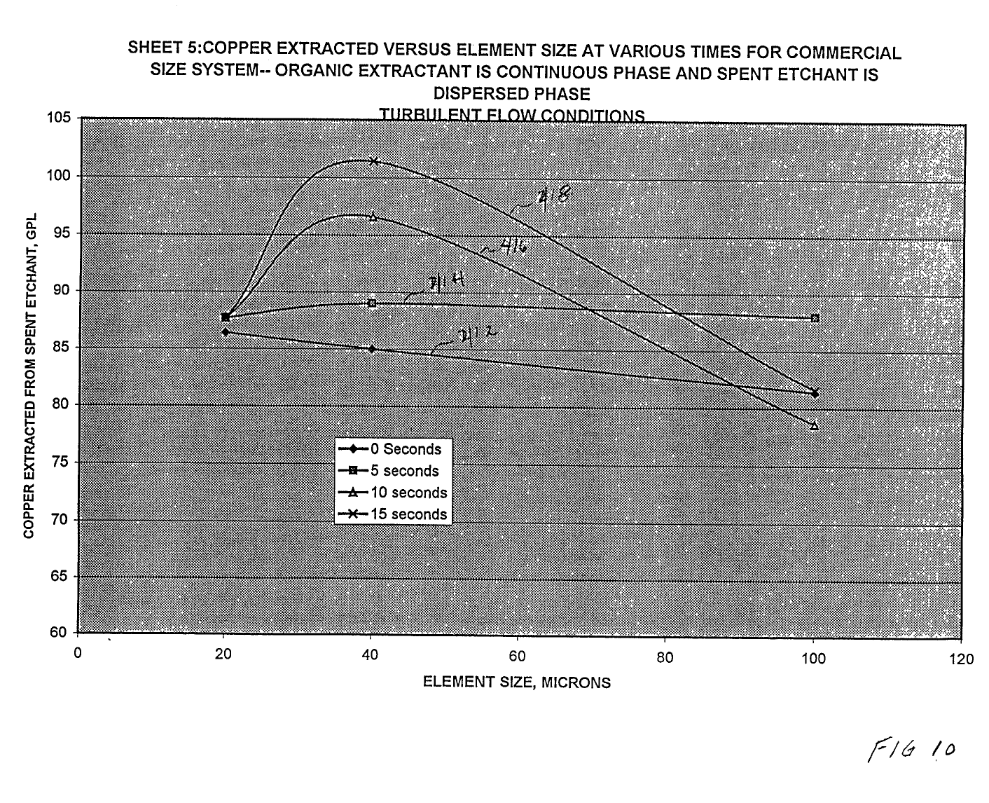

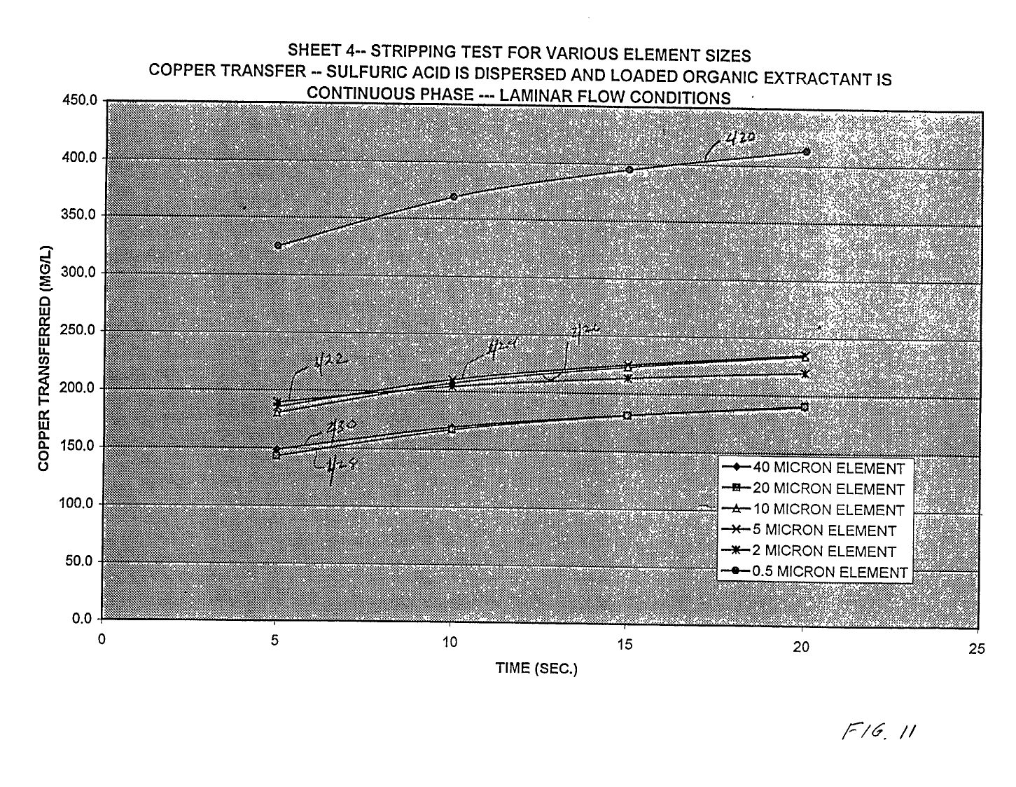

The data plotted in FIG. 10 shows the advantage of using turbulent flow provided by the apparatus of FIG. 1 to recover copper from aqueous spent etching solution (copper concentration 122 gpl; pH 8.5; chloride concentration 154 gpl; and free ammonia 4.9N) as the disbursed phase in the organic liquid extraction. Curves 412, 414, 416, and 418 show the recovery of copper from spent ammoniacal etching solution at travel times from the mixer of 0, 5, 10, and 15 seconds. Referring to curve 418 (a travel time of 15 seconds) more than 100 grams of copper per liter were recovered using a permeable body with a nominal pore size of 40 microns. FIG. 9 (curve 410) shows that only about 65 grams of copper per liter were recovered under similar conditions using the laminar flow described above. Moreover, the aqueous spent etchant solution used for the data presented in FIG. 10 contained only 122 grams per liter of copper as compared to 136.1 grams per liter for the data presented in FIGS. 8 and 9. This clearly demonstrates the advantage of using the turbulent flow for increasing copper recovery.

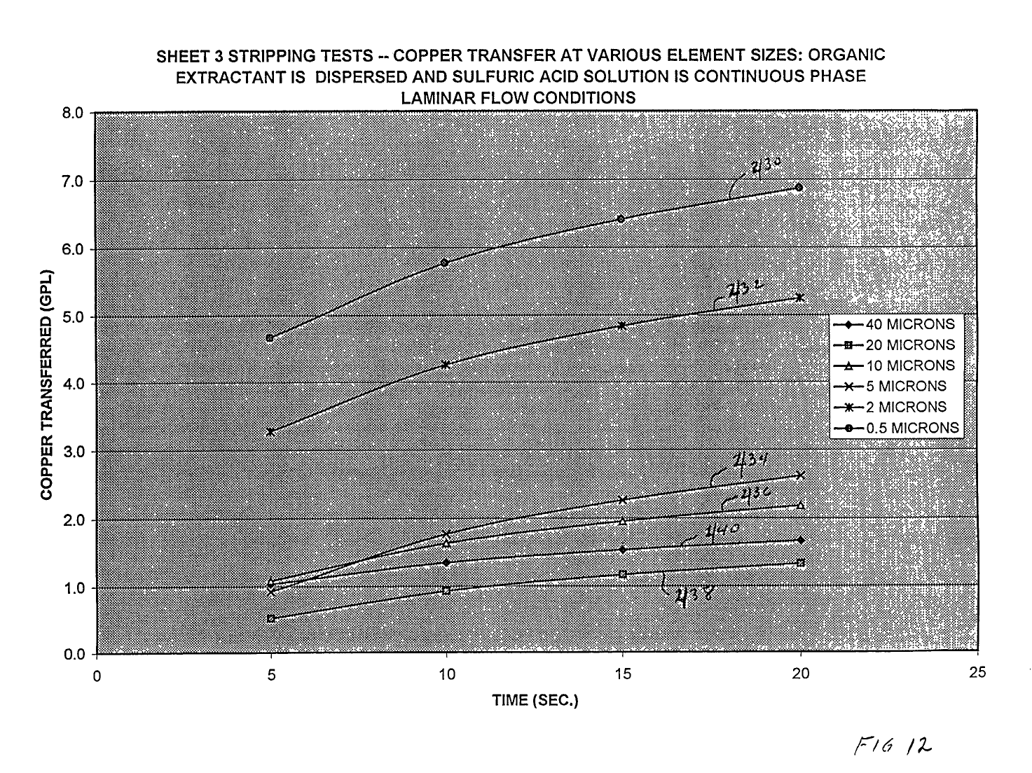

The data presented in FIGS. 11 and 12 compare copper transferred in stripping tests under laminar flow conditions with the aqueous liquid dispersed (FIG. 11) and with the organic liquid dispersed (FIG. 12). Referring to FIG. 11, curves 420, 422, 424, 426, 428, and 430 show copper recovered (in milligrams per liter) when an aqueous stripping solution of sulphuric acid was disbursed as the discontinuous phase in an organic liquid extractant loaded with copper (10.92 grams per liter). The sulphuric acid solution contained 180 grams per liter sulphuric acid. The data shown in FIG. 11 were obtained by filling the column (not shown) with the copper-loaded organic liquid extractant, and dispersing the aqueous sulphuric acid solution through the permeable body. The aqueous acid stripping solution was collected at the bottom of the column and analyzed for copper. As shown by the curves in FIG. 11, even when using the permeable body with the smallest pore size (0.5 microns), less than 0.4 grams of copper per liter were recovered with a residence time of 15 seconds. FIG. 12 presents data in curves 430, 432, 434, 436, 438, and 440 showing the amount of copper stripped at various reaction times for permeable bodies having pore sizes nominally designated as 0.5, 2, 5, 10, 20, and 40 microns, respectively. Using a permeable body with a pore size of 0.5 microns, more than 6 grams of copper per liter were recovered for a reaction time of 15 seconds when the organic liquid was the dispersed phase. This is more than 15 times the amount of copper recovered when the aqueous liquid was the dispersed phase.

Although the permeable body with the smallest pore sizes achieve greater copper transfer than permeable bodies with larger pores, I presently prefer to use a permeable body having a pore size of about 40 microns because that provides good recovery, relatively low pressure drop across the wall of the permeable body, faster and more complete coalescence of the disbursed phase, and minimum problems with respect to plugging of the permeable body.

I claim:

1. In apparatus for dispersing a first fluid in a second fluid, the combination comprising:
a permeable body having a recess in it for receiving a first fluid which can flow from the recess through the permeable body to the exterior of the body;
a housing surrounding and spaced from the permeable body, the housing having an inlet for a second fluid and an outlet for a mixture of the first and second fluids; and
a baffle in the space between the permeable body and the housing, the baffle having an outer portion adjacent the housing interior and an inner portion adjacent the body exterior, the baffle being shaped to define a winding mixing channel through the space between the body and the housing so the second fluid can enter the housing inlet and flow through the winding mixing channel to the outlet and mix with the first fluid, which can flow from the recess through the permeable body and into the winding channel.

2. Apparatus according to claim 1, in which the mixing channel is substantially in the shape of a helix.

3. Apparatus according to claim 1 or 2, in which the baffle is made of a series of elongated segments disposed end-to-end.

4. Apparatus according to claim 1 or 2, in which the permeable body has pores, the majority of which have equivalent diameters between about 0.5 and about 200 microns.

5. Apparatus according to claim 1 or 2, in which the permeable body is made up of solid particles fused together by sintering.

6. Apparatus according to claim 5, in which the particles are metallic.

7. Apparatus according to claim 1 or 2, in which the permeable body is made of ceramic material.

8. A segment for use as a baffle, the segment comprising an elongated substantially flat strip having inner and outer edges disposed along a path in the general shape of an ellipse having a major axis and a minor axis, the strip being wider where it crosses the major axis than where it crosses the minor axis.

9. A segment according to claim 8, in which a first part of the strip on one side of the major axis where the strip crosses the minor axis is closer to the major axis than a second part of the strip on the other side of the major axis where the second part of the strip crosses the minor axis.

10. A segment according to claim 8 or 9, in which the strip has an inner border and an outer border, and in which the inner and outer borders of the strip are substantially parallel, and the inner border forms a ceratoid cusp in the vicinity of the minor axis.

11. A segment according to claim 8 or 9, in which the ends of the strip are in the vicinity of the minor axis.

12. A segment according to claim 10, in which the ends of the strip are in the vicinity of the minor axis and the ceratoid cusp.

13. A segment according to claim 11, in which the ends of the strip are substantially parallel to the major axis.

14. A segment according to claim 12, in which the ends of the strip are substantially parallel to the minor axis.

15. A segment according to claim 8 or 9, in which the segment has ends adjacent each other in the vicinity of the minor axis, and the segment is shaped so that when the ends of the strip are moved relative to each other in a direction substantially parallel to a third axis which is perpendicular to the major and minor axes, the outer and inner edges of the strip each respectively make a snug fit against the inner surface of a first pipe and the outer surface of a second pipe coaxially disposed within the first pipe.

16. Apparatus for transferring material in a first liquid to a second liquid which has an affinity for the material and is substantially immiscible in the first liquid, and for transferring material in the second liquid to a third liquid which has an affinity for the material and is substantially immiscible in the second liquid, the apparatus comprising:
a first mixer which includes a first permeable body having a first and a second side, a first flow channel for directing the first liquid against the first side of the body to cause the first liquid to flow through the body and emerge from the second side of the body, and a second flow channel for directing the second liquid to flow in contact with the second side of the first body to form a first dispersion of droplets of the first liquid in the second liquid so material transfers from the first to the second liquid;
a first separator having an inlet connected to the first mixer to receive the first dispersion from the first mixer, the separator having a first outlet for the first liquid from which material has been removed and a second outlet for the second liquid with material transferred to it; and
a second mixer which includes a second permeable body having a first side and a second side, a first flow channel connecting the second outlet of the separator to direct the second liquid with material in it against the first side of the second body to cause the second liquid and material in it to flow through the second body and emerge from the second side of the second body, and second flow channel for directing the third liquid to flow in contact with the second side of the second body to form a second dispersion in which droplets of the second liquid with material are dispersed in a continuous phase of the third liquid so material transfers from the second to the third liquid.

17. A method for dispersing a first liquid in a second liquid, the method including the steps of:
a) forcing the first liquid through a permeable body so the first liquid emerges from the body in the form of droplets; and
b) flowing the second liquid past the body where the droplets emerge from the body to form a dispersion of substantially uniform droplets of the first liquid in the second liquid.

18. A method according to claim 17 which includes flowing the second liquid past the body under turbulent flow conditions.

19. A method according to claim 18, in which the Reynolds number for the flowing second liquid is greater than about 5000.

20. A method according to claim 17 or 18, in which the two liquids are substantially mutually insoluble.

21. A method according to claim 17 or 18, in which the two liquids are substantially mutually insoluble, and thereafter separating the two liquids after dispersing the first liquid in the second liquid.

22. A method according to claim 21, in which the two liquids are separated by centrifugal action.

23. A method according to claim 17 or 18, in which the permeable body has pores, and the majority of the pores have equivalent diameters between about 0.5 and about 200 microns.

24. A method according to claim 17 or 18, in which the permeable body is made of sintered metal particles.

25. A method according to claim 17 or 18, in which the permeable body is made of ceramic material.

26. A method for transferring material in a first liquid to a second liquid which is substantially insoluble in the first liquid, and which includes an agent which has an affinity for the material, the method comprising:
a) passing the first liquid and material through a permeable body; and
b) contacting the first liquid and material which pass through the body with the second liquid.

27. A method according to claim 26, in which droplets of the first liquid are dispersed in the second liquid.

28. Apparatus according to claim 26 or 27, in which the permeable body is made of porous metal.

29. A method according to claim 26 or 27, in which the permeable body has pores, the majority of which have equivalent diameters between about 0.5 and about 200 microns.

30. A method for recovering material dissolved in an aqueous solution which comprises:
a) passing the aqueous solution of dissolved material through a permeable body; and
b) contacting the aqueous solution and dissolved material which pass through the body with an agent which has an affinity for the material, and which is in a liquid form substantially immiscible with water.

31. A method of recovering material in an organic liquid which is substantially immiscible with water, the method comprising:
a) passing the organic liquid and material through a permeable body; and
b) contacting the organic liquid and material which pass through the body with an aqueous liquid solution having an affinity for the material.

32. A method according to claim 30 or 31, in which the permeable body is made of porous metal.

33. A method according to claim 30 or 31, in which the permeable body has pores, the majority of which have equivalent diameters between about 0.5 and about 200 microns.

34. A method according to claim 30 or 31, in which the liquid having the affinity for the material flows under turbulent conditions.
